(19) United States
(12) Patent Application Publication
(10) Pub. No.: US 2019/0047711 A1
(43) Pub. Date: Feb. 14, 2019

(54) AIRCRAFT COMPRISING AN AIR CONDITIONING DEVICE POSITIONED IN THE NOSE OF THE AIRCRAFT

(71) Applicant: Airbus Operations SAS, Toulouse (FR)

(72) Inventors: Bernard GUERING, MONTRABE (FR); Laurent SAINT-MARC, MONTAIGUT SUR SAVE (FR)

(21) Appl. No.: 16/057,085

(22) Filed: Aug. 7, 2018

(30) Foreign Application Priority Data
Aug. 8, 2017 (FR) 1757580

(51) Int. Cl. B64D 13/08; B64D 13/06

(52) U.S. Cl. CPC B64D 13/08; B64D 2013/0625; B64D 2013/0688; B64D 13/06

(57) ABSTRACT

An aircraft comprising an air conditioning device positioned at least in part in the nosecone of the aircraft. This novel integration architecture makes it possible to reduce the volume of the belly pan of the aircraft and improve the aerodynamic performance thereof.

### CROSS-REFERENCES TO RELATED APPLICATIONS

This application claims the benefit of the French patent application No. 1757580 filed on Aug. 8, 2017, the entire disclosures of which are incorporated herein by way of reference.

### BACKGROUND OF THE INVENTION

The present application relates to an aircraft comprising an air conditioning device positioned in the nosecone of the aircraft.

As illustrated in FIGS. 1 and 2, an aircraft 10 comprises a fuselage 12 which extends from a nosecone 14 as far as a tail cone 16, as well as two wings 18, 18′.

In order to move around on the ground, the aircraft comprises a nose landing gear 20 positioned under the nosecone 14 and two main landing gears 22, 22′ positioned under the wings 18, 18′. Each landing gear 20, 22, 22′ is able to move between a deployed position and a position in which it is folded up inside a random gear bay.

The landing gear bays intended for the main landing gear 22, 22′ are positioned inside a belly fairing 24 positioned underneath the fuselage 12 in the region where the fuselage 12 and the wings 18, 18′ meet.

As illustrated in FIGS. 3A and 3B, the aircraft also comprises at least one cabin 26 the air of which is conditioned to determined conditions suited to the people present in the cabin. For this purpose, the aircraft comprises a conditioned-air production and distribution assembly which comprises:

a recirculation circuit 28 configured to draw air from the cabin 26,

an air conditioning device which comprises:

two treatment systems 30 configured to adapt the air drawn from the motive-power units to the determined conditions,

a mixing system 32 configured to mix the air treated by the treatment systems 30 with the air drawn from the cabin 26 and conveyed by the recirculation circuit 28, and

a fresh-air distribution circuit 34 configured to carry the air leaving the mixing system 32 as far as the cabin 26.

The air conditioning device which comprises the treatment systems 30 and the mixing system 32 is positioned inside the belly fairing 24. The mixing system 32 is positioned in the middle and the treatment systems 30 are positioned on each side of the mixing system 32 at the rear of the zones where the wings 18, 18′ meet the fuselage 12.

As illustrated in FIG. 4, each treatment system 30 comprises a cooling-air circuit 36 which extends from a scoop 38 that opens onto the belly fairing 24, more particularly in the zone situated to the rear of each wing 18, 18′, as far as an air outlet 40 which is offset toward the rear of the aircraft in relation to the scoop 38, and a hot-air circuit 42 which extends from a motive-power unit as far as the mixing system 32.

Each treatment system 30 also comprises, in the direction in which the stream of air circulating in the hot-air circuit 42 flows, a first heat exchanger 44 exchanging heat between the cooling circuit 36 and the hot-air circuit 42, a compressor 46, a second heat exchanger 44′ exchanging heat between the cooling circuit 36 and the hot-air circuit 42, a heater 48, a condenser 50, a water extractor 52 and a blower 54.

On leaving the blower 54, the air coming from the motive-power units is dried and is at the required temperature and pressure for mixing in the mixing system 32.

In order for the scoops 38 of the two air-treatment systems 30 to be effective, they need to be positioned on each side of the fuselage. As a result, the two air treatment systems 30 are separated and positioned on each side of the widest cross section of the aircraft.

The mixing system 32 comprises a mixer 56 in which the air from the air treatment systems 30 and the air from the recirculation circuit 28 is mixed, as well as various accessories for treating the air, in particular, such as for example, filters 58, and/or for regulating its flow, such as, for example, a circulation blower 60. According to one embodiment visible in FIG. 5, the mixer 56 is oriented vertically, the ducts of the recirculation circuit 28 and of the treatment systems 30 being connected to the lower part of the mixer 56 and the ducts of the fresh-air distribution circuit 34 being connected in the upper part.

Because the mixing system 32 and its accessories is becoming increasingly bulky, because of ever increasing requirements for climate-controlled air, and because the air treatment systems 30 are spaced apart, the belly fairing 24 needs to cover a significant volume and forms outgrowths 62 on each side of the fuselage, as illustrated in FIG. 2, which have an impact on the aerodynamic performance of the aircraft and, therefore, on the fuel consumption of the aircraft.

The present invention seeks to overcome the disadvantages of the prior art.

### SUMMARY OF THE INVENTION

To this end, the subject of the invention is an aircraft comprising a fuselage which has a nosecone which comprises, under a floor, a main technical compartment and a forward zone in which a nose gear bay is positioned, the aircraft comprising a conditioned-air production and distribution assembly which comprises at least:

a recirculation circuit configured to draw air from at least one cabin of the aircraft,

a conditioned-air distribution circuit configured to inject conditioned air into the cabin,

an air conditioning device which comprises:

at least one air treatment system, and

a mixing system configured to mix the air treated by the air treatment system(s) with the air drawn from at least one cabin and conveyed by the recirculation circuit,

According to the invention, the air conditioning device comprises a majority of elements positioned at the periphery of the landing gear bay. Because the air conditioning device is no longer positioned inside the belly fairing, it is possible to reduce the dimensions of said belly fairing and therefore to improve the aerodynamic performance of the aircraft.

According to another feature, the mixing system comprises a horizontally oriented mixer which has at least one mixer outlet oriented toward the front of the aircraft and connected to the conditioned-air distribution circuit.

According to another feature, the mixer comprises at least one mixer inlet connected to a manifold positioned to the rear and in the extension of the mixer, the manifold having at least one inlet connected to the recirculation circuit.

According to one integration architecture, with the forward zone comprising, in addition to the nose gear bay, a secondary technical compartment positioned on top of the nose gear bay, the mixer is positioned on top of the nose gear bay in the secondary technical compartment. The manifold is offset rearward with respect to the nose gear bay.

According to another feature, each air treatment system comprises:

a cooling-air circuit which extends from a first scoop opening in the region of the fuselage of the nosecone as far as an air outlet which opens in the region of the fuselage and is offset toward the rear of the aircraft with respect to the first scoop, and

an air conditioning circuit which extends from a second scoop as far as an outlet connected to the mixer and which comprises equipment for conditioning the air drawn from outside the aircraft to determined conditions, such as at least one heat exchanger for the exchange of heat between the air flows circulating in the cooling air circuit and in the air conditioning circuit.

According to another feature, the outlet of each air conditioning circuit is connected at the lower part of the manifold.

According to one integration architecture, the majority of the equipment for each air conditioning circuit is positioned on either side of the manifold.

The first and second scoops and the exchangers are positioned in the secondary technical compartment, on each side of the nose gear bay.

### BRIEF DESCRIPTION OF THE DRAWINGS

Further features and advantages will become apparent from the description of the invention which will follow, which description is given solely by way of example, with reference to the attached drawings among which:

FIG. 1 is a side view of an aircraft,

FIG. 2 is a front view of an aircraft illustrating the prior art,

FIG. 3A is a schematic depiction, as seen from the side, of an aircraft equipped with a conditioned-air production and distribution assembly as illustrated by the prior art,

FIG. 3B is a schematic front-on view of an aircraft equipped with a conditioned-air production and distribution assembly illustrating the prior art,

FIG. 4 is a perspective view of an air treatment system illustrating one embodiment of the prior art,

FIG. 5 is a perspective view of a mixing system illustrating one embodiment of the prior art,

FIG. 6A is a schematic side view depiction of an aircraft equipped with a conditioned-air production and distribution assembly illustrating one embodiment of the invention,

FIG. 6B is a schematic face-on depiction of an aircraft equipped with a conditioned-air production and distribution assembly illustrating one embodiment of the invention,

FIG. 7 is a side view of a nosecone of an aircraft incorporating an air conditioning device illustrating one embodiment of the invention,

FIG. 8 is a rear view of a nosecone of an aircraft incorporating an air conditioning device illustrating one embodiment of the invention,

FIG. 9 is a plan view of a nosecone of an aircraft incorporating an air conditioning device illustrating one embodiment of the invention,

FIG. 10 is a perspective view from the top of an air conditioning device illustrating one embodiment of the invention, and

FIG. 11 is a perspective view from underneath of an air conditioning device illustrating one embodiment of the invention.

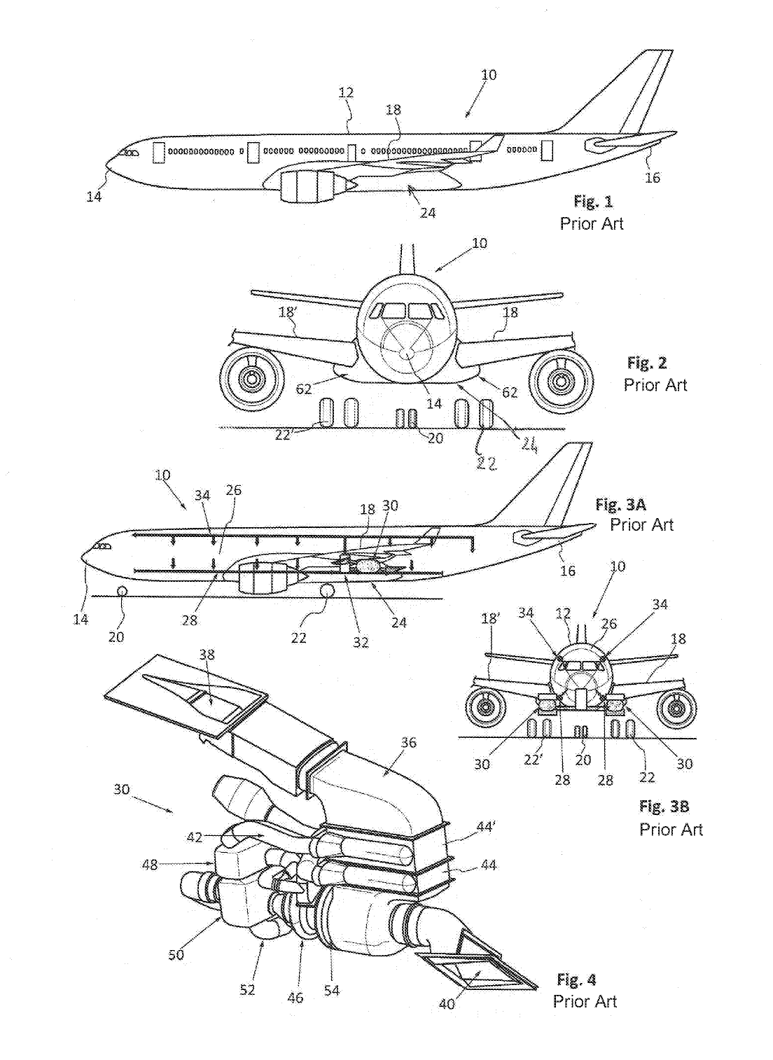

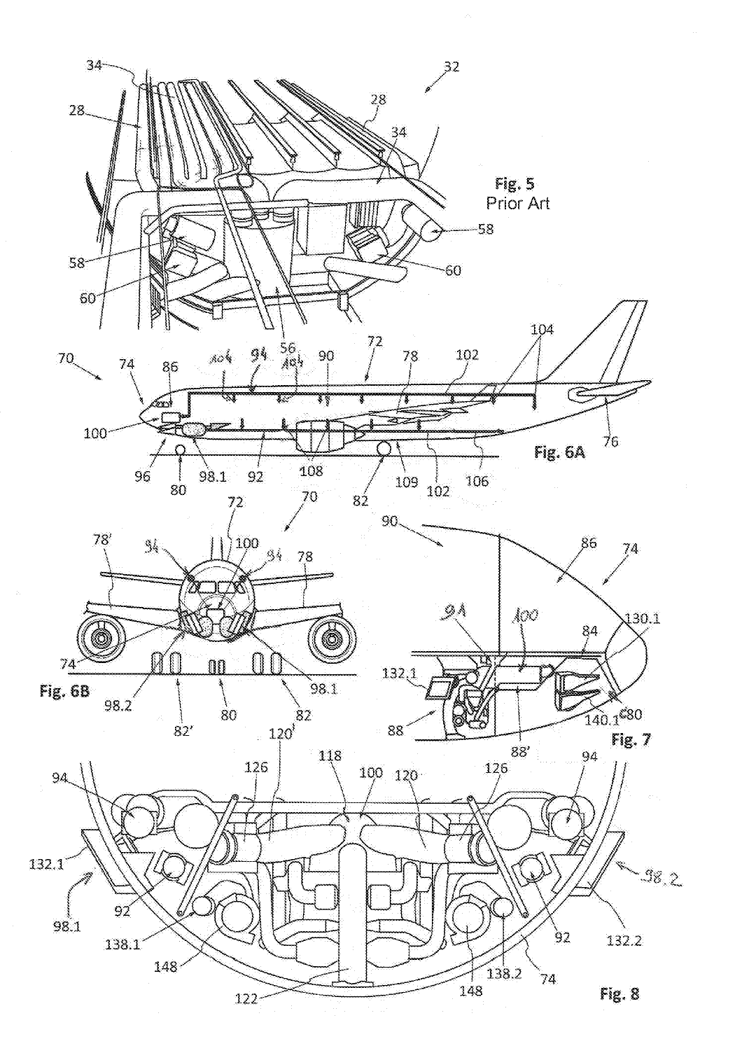

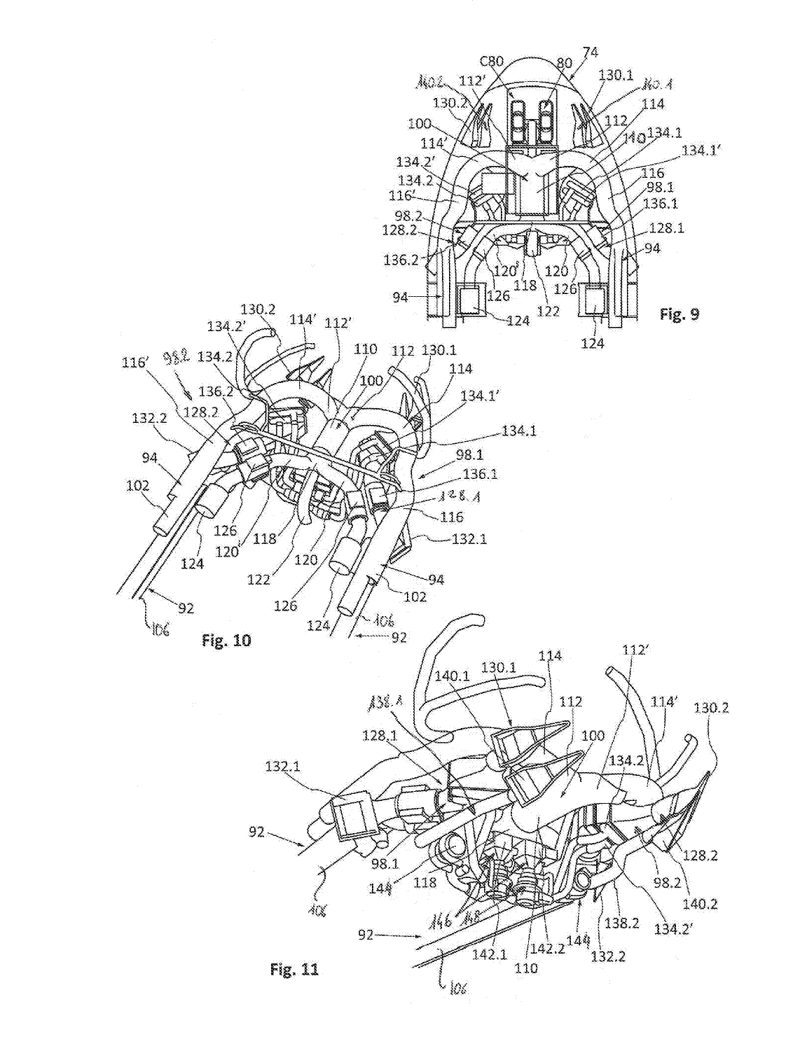

### DETAILED DESCRIPTION OF THE PREFERRED EMBODIMENTS

As illustrated in FIGS. 6A and 6B, an aircraft 70 comprises a fuselage 72 which extends from a nosecone 74 as far as a tail cone 76, as well as two wings 78, 78′ connected to the fuselage 72. Between the nosecone 74 and the tail cone 76, the fuselage 72 is made up of sections.

In the remainder of the description, a longitudinal direction is parallel to the longitudinal axis of the aircraft also referred to as the roll axis. A transverse plane is a plane perpendicular to the longitudinal direction, a vertical midplane is a vertical plane passing through the axis of revolution of the sections of the fuselage 72. The terms front and rear refer to the direction in which the air flows around the aircraft in flight, the front end of the fuselage of the aircraft penetrating the air.

The nosecone 74 corresponds to that portion of the fuselage 72 which is situated at the front end of the fuselage, which has an evolving cross section which decreases from the rear forward until it becomes zero and which is contiguous with another portion of the fuselage that has a substantially constant cross section.

In order to move around on the ground, the aircraft comprises a nose landing gear 80 and two main landing gears 82, 82′ positioned under the wings 78, 78′. Each landing gear 80, 82, 82′ is able to move between a deployed position and a position in which it is folded up inside a landing gear bay.

The nose gear bay C80 intended for the nose landing gear 80 is positioned in the nosecone 74.

As illustrated in FIG. 7, the nosecone 74 is split into at least two zones which are superposed and separated by a floor 84. The nosecone 74 comprises, on top of the floor 84, a cabin referred to as a cockpit 86 and, under the floor 84, a forward zone in which the nose gear bay C80 is positioned and a rear zone which forms a main technical compartment 88. That part of the forward zone that is interposed between the nose gear bay C80, the floor 84 and the main technical compartment 88 is referred to as the secondary technical compartment 88′. The main technical compartment 88 and the secondary technical compartment 88′ are separated by a transverse plane 91 positioned in the same plane as the rear wall of the nose gear bay C80.

The aircraft 70 comprises, inside the fuselage 72, at least one cabin 90, the air of which is conditioned to determined characteristics suited to the people present in the cabin 90. The cockpit 86 can be likened to a cabin and therefore happens to be one of the cabins having conditioned air. The passenger cabin is another.

For this purpose, the aircraft comprises a conditioned-air production and distribution assembly which comprises at least:

a recirculation circuit 92 configured to draw air from at least one cabin 90 of the aircraft,

a conditioned-air distribution circuit 94 configured to inject conditioned air into the cabin 90,

an air conditioning device 96 which comprises:

at least one air treatment system 98.1, 98.2, and

a mixing system 100 configured to mix the air treated by the air treatment system(s) 98.1, 98.2 with the air drawn from at least one cabin 90 and conveyed by the recirculation circuit 92.

In general, the air conditioning device 96 comprises two air treatment systems 98.1, 98.2 arranged symmetrically with respect to the vertical midplane of the aircraft.

According to one embodiment, the conditioned-air distribution circuit 94 comprises several ducts 102 allowing the air leaving the mixing system 100 to be ducted as far as several ventilation outlets 104. The recirculation circuit 92 comprises several ducts 106 allowing air present in the cabin 90 to be collected via suction outlets 108 and ducted as far as the mixing system 100.

The recirculation circuit 92 and the conditioned-air distribution circuit 94 are not described further because they may be identical to those of the prior art.

According to one feature of the invention, the air conditioning device 96 is positioned, at least in part, in the nosecone 74 of the aircraft. Moving the air conditioning device from inside the belly fairing 109 to the nosecone 74 makes it possible to reduce the dimensions of the belly fairing 109 and therefore improve the aerodynamic performance of the aircraft.

The mixing system 100 comprises a horizontally oriented mixer 110 which has at least one mixing outlet 112 connected to the conditioned-air distribution circuit 94. According to one embodiment, the mixer 110 comprises two mixer outlets 112, 112′ oriented toward the front of the aircraft, each mixer outlet 112, 112′ being connected respectively to a bent duct 114, 114′ configured to reorient the air flow toward the rear of the aircraft. Each bent duct 114, 114′ communicates with a conditioned-air distribution duct 116, 116′ connected to the conditioned-air distribution circuit 94.

The mixer 110 comprises at least one mixer inlet connected to a manifold 118 positioned to the rear and in the extension of the mixer 110, the manifold 118 having at least one inlet connected to the recirculation circuit 92.

According to one embodiment, the manifold 118 comprises first and second ducts 120, 120′ oriented toward the rear of the aircraft and connected to the recirculation circuit 92, and a central duct 122 configured to be able to connect a source of air external to the aircraft.

The mixing system 100 also comprises accessories in order, in particular, to treat the air, such as, for example, filters 124 and/or to regulate the air, such as, for example, blowers 126.

In one configuration, the mixer 110 and the bent ducts 114, 114′ are positioned above the nose gear bay C80 in the secondary technical compartment 88′. The manifold 118 and the accessories, such as the filters 124 and the blowers 126, are offset toward the rear in relation to the nose gear bay C80, in the main technical compartment 88.

Each air treatment system 98.1, 98.2 comprises a cooling-air circuit 128.1, 128.2 which extends from a first scoop 130.1, 130.2 opening in the region of the fuselage of the nosecone 74 as far as an air outlet 132.1, 132.2 opening in the region of the fuselage and offset toward the rear of the aircraft in relation to the scoop 130.1, 130.2.

Positioning the first scoops 130.1, 130.2 in the region of the nosecone 74, which has an evolving cross section which increases from the front rearward, encourages air to enter the cooling-air circuit 128.1, 128.2.

Each cooling-air circuit 128.1, 128.2 comprises, in the direction in which the air stream flows, at least one heat exchanger 134.1, 134.1′ and 134.2, 134.2′ and a blower 136.1, 136.2.

Each air treatment system 98.1, 98.2 comprises an air conditioning circuit 138.1, 138.2 which extends from a second scoop 140.1, 140.2 as far as an outlet 142.1, 142.2 connected to the mixer 110, notably via the manifold 118, and which comprises equipment for conditioning the air led from outside the aircraft to the determined characteristics, in terms of temperature, pressure and/or flow rate, to be injected into the conditioned-air distribution circuit via the mixing system 100. This equipment comprises at least a heat exchanger 134.1, 134.2, 134.1′, 134.2′ for the exchange of heat between the air streams circulating in the cooling air circuit 128.1, 128.2 and the air conditioning circuit 138.1, 138.2.

Insofar as the manifold 118 is positioned to the rear of the nose gear bay C80, in the continuation of the manifold 110 which is positioned above the gear bay C80, the manifold 118 is spaced away from the fuselage 72, and this allows the outlet 142.1, 142.2 of each air conditioning circuit 138.1, 138.2 to be connected in the lower part of the manifold 118. This region situated between the manifold 118 and the fuselage 72 allows at least some of the equipment of the air conditioning circuits 138.1, 138.2 to be integrated. Thus, the majority of the equipment of the air conditioning circuits 138.1, 138.2 is positioned underneath and on either side of the manifold 118, making it possible to achieve a very compact integration and making access to these various equipment items easier.

According to one embodiment, the equipment of the air conditioning circuits 138.1 and 138.2 comprises, notably in the direction in which the stream of air flows, a first heat exchanger 134.1, 134.2 for exchange of heat between the cooling air circuit 128.1, 128.2 and the air conditioning circuit 138.1, 138.2, a compressor 144, a second heat exchanger 134.1′, 134.2′ for exchange of heat between the cooling-air circuit 128.1, 128.2 and the air conditioning circuit 138.1, 138.2, a water extraction system 146 and a blower 148.

According to one embodiment, the first and second scoops 130.1, 130.2, 140.1, 140.2 and the exchangers 134.1, 134.2, 134.1′, 134.2′ are positioned in the secondary technical compartment 88′ on each side of the nose gear bay C80. The first and second scoops 130.1, 130.2, 140.1, 140.2 are positioned substantially in the one same transverse plane, the second scoops 140.1 and 140.2 being offset downward in relation to the first scoops 130.1 and 130.2.

The blowers 136.1, 136.2 and the air outlets 132.1 and 132.2 of the cooling air circuit 128.1, 128.2 are arranged in the main technical compartment 88.

The other equipment of the other air conditioning circuits 138.1, 138.2 is also positioned in the main technical compartment 88 underneath the manifold 118, the outlets 142.1, 142.2 of the air conditioning circuits 138.1, 138.2 being connected underneath the manifold 118 of the mixer 110.

The fact that the mixer 110 is arranged horizontally in the secondary technical compartment 88′ on top of the nose gear bay C80 and the heat exchangers 134.1, 134.1′ and 134.2, 134.2′ of the air treatment systems 98.1, 98.2 on each side of the landing gear bay makes it possible to obtain a compact assembly which optimizes the use of space in the secondary technical compartment 88′.

According to the invention, the majority of the elements that make up the air conditioning device 96 are positioned at the periphery of the nose gear bay C80.

Both parts of the air treatment systems 98.1 and 98.2 and of the mixing system 100 that are positioned in the main technical compartment 88 are relatively compact because the outlets of the air conditioning circuits 138.1, 138.2 are connected underneath the manifold 118 of the mixer 110. As a result, the air conditioning device 96 takes up only a small amount of space in the main technical compartment 88.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
a fuselage which has a nosecone comprising:
under a floor, a main technical compartment and a forward zone in which a nose gear bay is positioned,
a conditioned-air production and distribution assembly comprising a plurality of elements comprising at least:
a recirculation circuit configured to draw air from at least one cabin of the aircraft,
a conditioned-air distribution circuit configured to inject conditioned air into the cabin,
an air conditioning device which comprises:
at least one air treatment system, and
a mixing system including a mixer configured to mix the air treated by the air treatment system with the air drawn from at least one cabin and conveyed by the recirculation circuit,
wherein the air conditioning device comprises a majority of said elements positioned at a periphery of the nose gear bay.

2. The aircraft as claimed in claim 1, wherein the mixer of the mixing system comprises a horizontally oriented mixer having at least one mixer outlet oriented toward a front of the aircraft and connected to the conditioned-air distribution circuit.

3. The aircraft as claimed in claim 2, wherein the mixer comprises at least one mixer inlet connected to a manifold positioned to a rear and in an extension of the mixer, the manifold having at least one inlet connected to the recirculation circuit.

4. The aircraft as claimed in claim 3, with the forward zone comprising the nose gear bay and a secondary technical compartment positioned above the nose gear bay, wherein the mixer is positioned above the nose gear bay, in the secondary technical compartment.

5. The aircraft as claimed in claim 4, wherein the manifold is offset rearward with respect to the nose gear bay.

6. The aircraft as claimed in claim 1, wherein each air treatment system comprises:
a cooling-air circuit extending from an opening of a first scoop a region of the fuselage of the nosecone as far as an air outlet opening in the region of the fuselage and being offset toward a rear of the aircraft with respect to the first scoop, and
an air conditioning circuit extending from a second scoop as far as an outlet connected to the mixer and comprising equipment for conditioning the air drawn from outside the aircraft to determined conditions, including at least one heat exchanger for an exchange of heat between air flows circulating in the cooling air circuit and in the air conditioning circuit.

7. The aircraft as claimed in claim 5, wherein each air treatment system comprises:
a cooling-air circuit extending from an opening of a first scoop in a region of the fuselage of the nosecone as far as an air outlet opening in the region of the fuselage and being offset toward the rear of the aircraft with respect to the first scoop, and
an air conditioning circuit extending from a second scoop as far as an outlet connected to the mixer and comprising equipment for conditioning the air drawn from outside the aircraft to determined conditions, such as at least one heat exchanger for an exchange of heat between air flows circulating in the cooling air circuit and in the air conditioning circuit, and
wherein the outlet of each air conditioning circuit is connected at a lower part of the manifold.

8. The aircraft as claimed in claim 7, wherein a majority of the equipment for each air conditioning circuit is positioned underneath and on either side of the manifold.

9. The aircraft as claimed in claim 6, the nosecone comprising, under a floor, a main technical compartment and a forward zone split between a nose gear bay and a secondary technical compartment positioned above the nose gear bay, wherein the first and second scoops and the exchangers are positioned in the secondary technical compartment on either side of the nose gear bay.
